(19) United States
(12) Patent Application Publication
(10) Pub. No.: US 2026/0319558 A1
(43) Pub. Date: Oct. 15, 2026

(54) THERMAL MANAGEMENT OPTIMIZATION METHOD, APPARATUS, AND A NON-TRANSITORY COMPUTER-READABLE STORAGE MEDIUM

(71) Applicant: WISTRON CORPORATION, New Taipei City (TW)

(72) Inventor: Chih Ming CHEN, New Taipei City (TW)

(73) Assignee: WISTRON CORPORATION, New Taipei City (TW)

(21) Appl. No.: 19/283,105

(22) Filed: Jul. 28, 2025

(30) Foreign Application Priority Data
Apr. 9, 2025 (TW) 114113437

(51) Int. Cl. G06F 1/20

(52) U.S. Cl. CPC G06F 1/206

(57) ABSTRACT

A thermal management optimization method, apparatus, and a non-transitory computer-readable storage medium are provided. The thermal management optimization apparatus includes an artificial intelligence model and a meta-controller. The artificial intelligence model generates predictive information based on sensed data. The meta-controller, coupled to the artificial intelligence model, generates a thermal management decision based on the predictive information and provides the thermal management decision to a thermal management system of a computing node for execution.

### CROSS-REFERENCE TO RELATED APPLICATION

This application claims the priority and benefit of Taiwan Application No. 114113437, filed on Apr. 9, 2025, the disclosure of which is hereby incorporated in its entirety by reference herein.

### TECHNICAL FIELD

The present disclosure relates to thermal management technology, and in particular to a thermal management optimization method, apparatus, and a non-transitory computer-readable storage medium.

### BACKGROUND

### Related Art

Traditional artificial intelligence models (such as supervised learning models, neural network models, reinforcement learning models, regression-based models and time series models) are typically trained in a fixed or known environment, and use historical data to make predictions or decisions. These models focus on a certain thermal load or environmental parameter and therefore lack an ability to adapt to dynamic changes. Once the model is trained, the parameters of the model are fixed, and it is difficult to self-adjust according to a real-time situation. If some particular situations (such as sudden high load) are not covered in model training, the model needs to be retrained or frequently fine-tuned, which is time-consuming and laborious.

### SUMMARY

An embodiment of the present disclosure provides a thermal management optimization method, including: generating, by using at least one artificial intelligence model, predictive information based on sensed data; generating, by a meta-controller, a thermal management decision based on the predictive information; providing the thermal management decision to a thermal management system of a computing node for execution; and executing the thermal management decision by at least one of: adjust an operation of a cooling system of the thermal management system, and adjust a workload distribution of the computing node.

An embodiment of the present disclosure provides a non-transitory computer-readable storage medium, storing a plurality of instructions loaded to execute the thermal management optimization method described above.

An embodiment of the present disclosure provides a thermal management optimization apparatus, including: at least one artificial intelligence model, a meta-controller, and a cooling device. The at least one artificial intelligence model generates predictive information based on sensed data. The meta-controller, coupled to the at least one artificial intelligence model, generates a thermal management decision based on the predictive information and provides the thermal management decision to a thermal management system of a computing node for execution. The cooling system is configured to execute the thermal management decision by adjusting at least one of: a liquid cooling device, and an air cooling device.

### BRIEF DESCRIPTION OF THE DRAWINGS

FIG. 1 is a schematic diagram showing an architecture of a thermal management optimization apparatus according to an embodiment of the present disclosure;

FIG. 2 is a schematic diagram showing an architecture of a rack according to an embodiment of the present disclosure;

FIG. 3 is a schematic diagram showing an architecture of a cooling system according to an embodiment of the present disclosure;

FIG. 4 is a schematic diagram showing an operation of a thermal management decision according to an embodiment of the present disclosure;

FIG. 5 is a schematic diagram showing an operation process of a cognitive computing system according to an embodiment of the present disclosure; and

FIG. 6 is a schematic diagram showing an operation process of a meta-optimizer according to an embodiment of the present disclosure.

### DETAILED DESCRIPTION

The same reference numerals in all drawings will be used to denote the same or similar components. The term “including” mentioned here is an open-ended term, so it should be interpreted as “including but not limited to”. As used herein, “coupled” means that two or more components “directly” make physical or electrical contact with each other or “indirectly” make physical or electrical contact with each other.

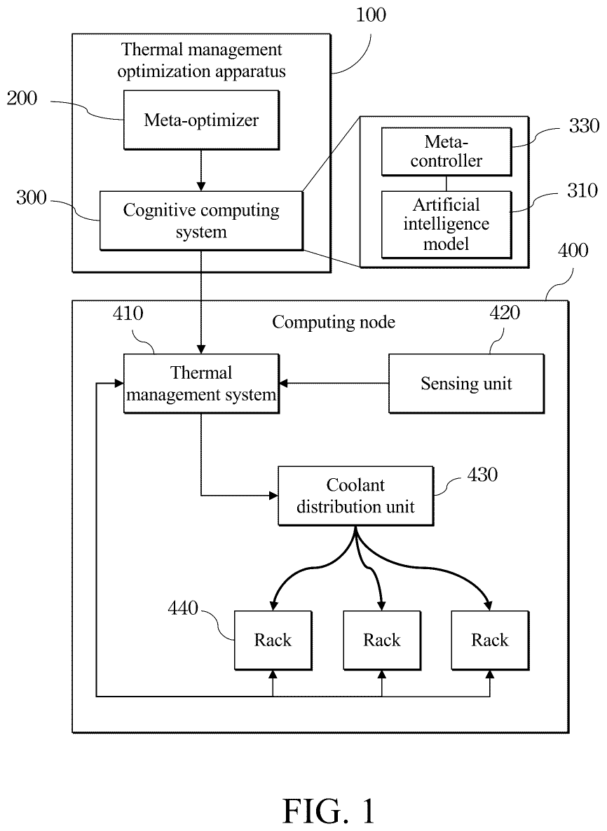

FIG. 1 is a schematic diagram showing an architecture of a thermal management optimization apparatus 100 according to an embodiment of the present disclosure. The thermal management optimization apparatus 100 executes a thermal management optimization method to help a computing node 400 execute thermal management. The execution of the thermal management optimization method may be achieved by reading a non-transitory computer-readable storage medium (not shown) and loading a plurality of instructions stored therein. The computing node 400 is, for example, a server, a server cluster or a data center. The computing node 400 includes a thermal management system 410, a sensing unit 420, a coolant distribution unit (CDU) 430 and at least one rack 440 (represented herein as a plurality of racks 440). The thermal management system 410 is coupled to the sensing unit 420, the coolant distribution unit 430 and the racks 440. The sensing unit 420 comprising one or more sensors, such as temperature sensors, thermal imaging devices, or power monitors, configured to collect real-time data from the computing node, which maintains flexibility while grounding the invention in a physical system.

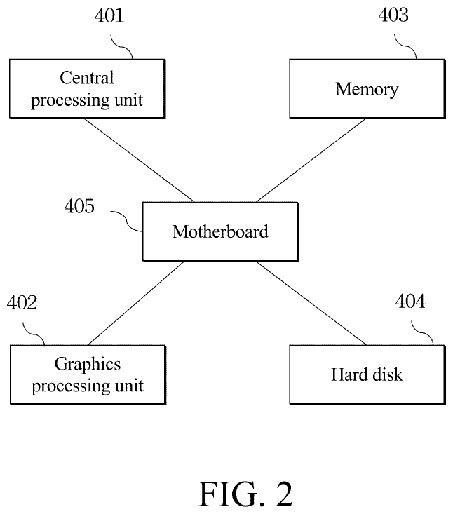

FIG. 2 is a schematic diagram showing an architecture of a rack 440 according to an embodiment of the present disclosure. The rack 440 includes a central processing unit 401, a graphics processing unit 402, a memory 403, a hard disk 404 and a motherboard 405. The central processing unit 401 and the graphics processing unit 402 respectively execute data and graphics processing. The memory 403 provides a data access function. The hard disk 404 is configured to store data. The central processing unit 401, the graphics processing unit 402, the memory 403 and the hard disk 404 are coupled through the motherboard 405 to cooperate with each other. The motherboard 405 is configured to supply power to the central processing unit 401, the graphics processing unit 402, the memory 403 and the hard disk 404, and has a heat dissipation system.

In some embodiments, the thermal management optimization apparatus 100 is deployed at the computing node 400. In other embodiments, the thermal management optimization apparatus 100 is another computing apparatus different from the computing node 400 that executes thermal management.

In some embodiments, a meta-optimizer 200 operates in the central processing unit 401. In some embodiments, a cognitive computing system 300 operates in the graphics processing unit 402.

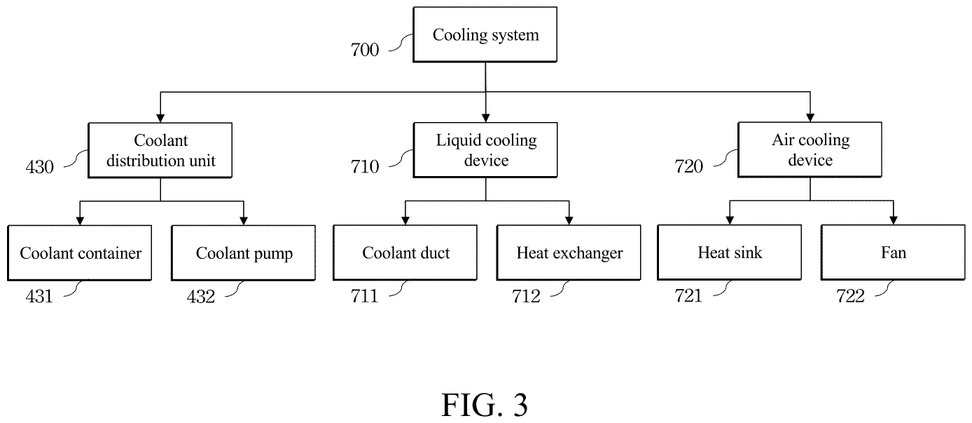

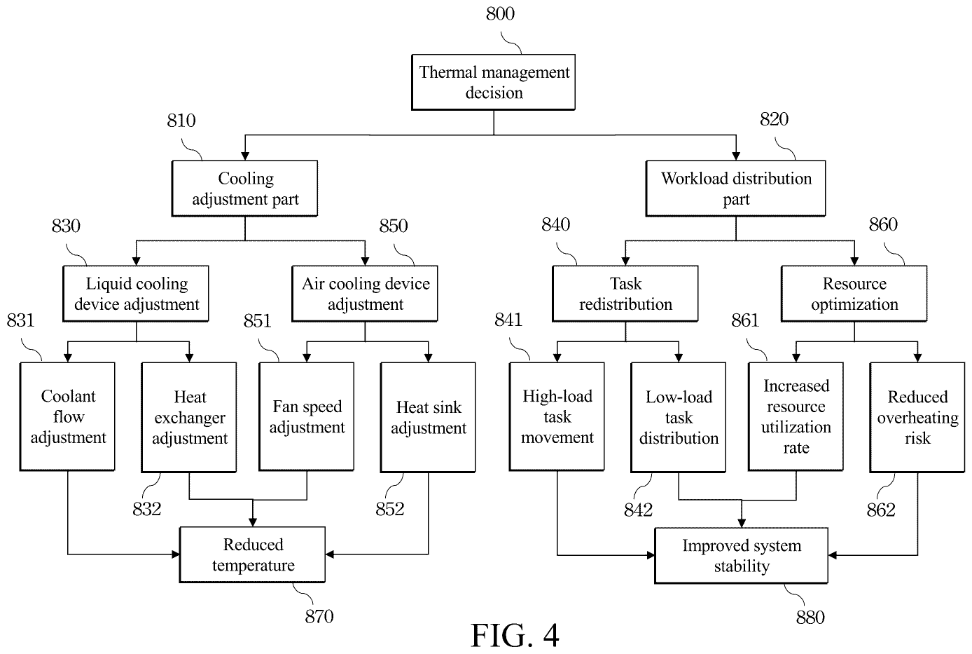

The thermal management system 410 integrates a monitoring system and a cooling system 700 (as shown in FIG. 3), and is configured to manage thermal energy generated by the computing of the racks 440, so as to prevent the racks 440 from overheating and ensure a computing performance of the racks 440. The monitoring system is configured to monitor a thermal profile of the computing node 400, and the thermal profile includes, for example, sensed data of the sensing unit 420 and a computing working state of each rack 440. The cooling system 700 is configured to control the thermal profile of the computing node 400 based on a thermal management decision 800 (as shown in FIG. 4), for example, to control the coolant distribution unit 430 to perform a cooling action (e.g., controlling an air cooling device 720 or/and a liquid cooling device 710).

FIG. 3 is a schematic diagram showing an architecture of a cooling system 700 according to an embodiment of the present disclosure. The cooling system 700 includes the coolant distribution unit 430, the liquid cooling device 710 and the air cooling device 720. The coolant distribution unit 430 includes a coolant container 431 and a coolant pump 432. The coolant container 431 is configured to store a coolant. The coolant pump 432 is coupled to the coolant container 431 so as to deliver the coolant out of the coolant container 431. The liquid cooling device 710 includes a coolant duct 711 and a heat exchanger 712. The coolant duct 711 is arranged in an area (heat generating area) that needs heat dissipation, and coupled to the coolant pump 432 so as to receive the coolant outputted by the coolant pump 432, so that the coolant can flow in the coolant duct 711 to take away heat in the heat generating area. The heat exchanger 712 is coupled to the coolant duct 711 so as to transfer heat of the coolant, such that the heat of the coolant is transferred to an outside of the cooling system 700. The air cooling device 720 includes a heat sink 721 and a fan 722. The heat sink 721 is arranged in the area (heat generating area) that needs heat dissipation so as to absorb and transfer the heat of the heat generating area. The fan 722 generates airflow so as to guide cool air to the heat sink 721 and take away the heat.

In some embodiments, there are a plurality of the sensing units 420, which respectively sense temperatures of internal components of the computing node 400, such as the temperature of the central processing unit 401, the temperature of the graphics processing unit 402, the temperature of the memory 403, the temperature of the hard disk 404, the internal temperature of the rack 440 or/and the external temperature of the rack 440. The sensing unit 420 also senses the temperature, humidity or/and airflow of the environment where the computing node 400 is located.

FIG. 4 is a schematic diagram showing an operation of a thermal management decision 800 according to an embodiment of the present disclosure. The thermal management decision 800 mainly includes a cooling adjustment part 810 and a workload distribution part 820.

The cooling adjustment part 810 executes: 1. liquid cooling device 710 adjustment (Block 830); and 2. air cooling device 720 adjustment (Block 850). The liquid cooling device 710 adjustment (Block 830) includes: 1. coolant flow adjustment (Block 831); and 2. heat exchanger 712 adjustment (Block 832). The air cooling device 720 adjustment (Block 850) includes: 1. fan 722 speed adjustment (Block 851); and 2. heat sink 721 adjustment (Block 852). Through Blocks 831, 832, 851 and 852, temperature control is executed, which leads to a reduced temperature (Block 870).

The workload distribution part 820 executes: 1. task redistribution (Block 840); and 2. resource optimization (Block 860). The task redistribution (Block 840) includes: 1. high-load task movement (Block 841); and 2. low-load task distribution (Block 842). The resource optimization (Block 860) is helpful to: 1. increased resource utilization rate (Block 861); and 2. reduced overheating risk (Block 862). Through Blocks 841, 842, 861 and 862, the system stability is improved (Block 880).

The thermal profile is affected by factors such as internal system configurations and external environment conditions. The internal system configurations include, for example, frequency rates of computing units (such as the central processing unit 401 and the graphics processing unit 402) of the racks 440, maximum power consumption limits of computing units, cooling mechanism (such as the liquid cooling device 710 and the air cooling device 720) settings, workload distribution, thermal throttling setting, task scheduling, computing resource distribution, parallel processing configurations, etc. The internal system configurations may be controlled by a basic input/output system (BIOS). a video BIOS (vBIOS), an operating system or/and an application program.

The external environment conditions include, for example, temperatures of internal components (e.g., computing units and the like) of the racks 440 or/and temperature, humidity, airflow (e.g., ventilation or air conditioning system) and spatial layout of the environment where the computing node 400 is located or/and power quality. The external environment conditions may also include workload type and intensity. Since the type of the computing task being processed may change over time (e.g., deep learning, artificial intelligence training and simulation), the heat generated fluctuates, so it also belongs to the external environment condition.

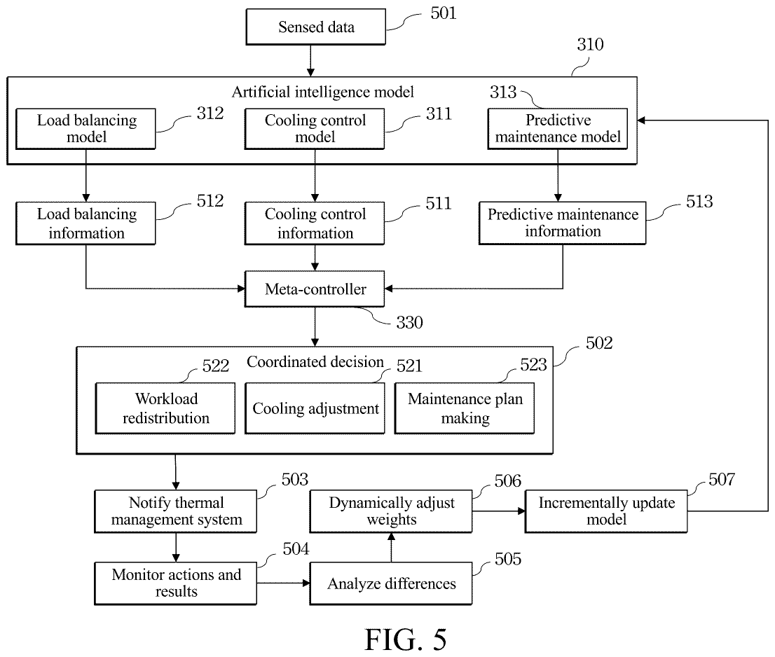

As shown in FIG. 1, the thermal management optimization apparatus 100 is coupled to the thermal management system 410. In an embodiment, the thermal management optimization apparatus 100 includes an artificial intelligence model 310 and a meta-controller 330. The meta-controller 330 manages and coordinates the artificial intelligence model 310 to form a cognitive computing system 300 (or a cognitive artificial intelligence system). The artificial intelligence model 310 generates predictive information based on sensed data 501 (as shown in FIG. 5) related to the aforementioned thermal profile. The meta-controller 330, coupled to the artificial intelligence model 310, generates a thermal management decision 800 (as shown in FIG. 4) based on the predictive information and provides the thermal management decision 800 to the thermal management system 410 of the computing node 400 for execution.

In some embodiments, the meta-controller 330 is a large language model (LLM). As the meta-controller 330 in the cognitive computing system 300, the large language model focuses on reasoning, interpretation and coordination. The meta-controller 330 processes outputs of the artificial intelligence model 310 and makes high-level decisions that meet thermal management objectives of the computing node 400. The meta-controller 330 does not modify itself, and maintains a fixed role to help the cognitive computing system 300 react flexibly according to different situations without damaging the completeness of the core objectives of the artificial intelligence model 310.

FIG. 5 is a schematic diagram showing an operation process of a cognitive computing system 300 according to an embodiment of the present disclosure. The objective of the cognitive computing system 300 is to optimize the efficacy, energy efficiency and reliability of thermal management of the computing node 400 within a fixed thermal profile range. In detail, the objective of the cognitive computing system 300 includes: 1. executing effective cooling control to minimize temperatures; 2. balancing the workload distribution to prevent overheating; 3. performing predictive maintenance and preventing failures; 4. performing coordinated management to ensure consistent performance within a fixed thermal profile range; 5. performing intelligent trade-off management to maximize the overall efficiency of the system; and 6. making scalable decisions with the growth of system requirements.

The artificial intelligence model 310 processes specific functions or tasks according to the sensed data 501. Here, the artificial intelligence model 310 includes a cooling control model 311, a load balancing model 312 and a predictive maintenance model 313, but the embodiments of the present disclosure are not limited thereto. The cooling control model 311 generates the predictive information including cooling control information 511 based on the sensed data 501. The load balancing model 312 generates the predictive information including load balancing information 512 based on the sensed data 501. The predictive maintenance model 313 generates the predictive information including predictive maintenance information 513 based on the sensed data 501. The predictive information is transmitted to the meta-controller 330 such that the meta-controller 330 reasons and interpret real-time data to make data-driven decisions.

In some embodiments, the cooling control model 311 is implemented based on machine learning techniques such as neural networks, decision trees or statistical models so as to predict temperature changes and dynamically adjust the cooling mechanisms. That is, the cooling control model 311 can detect abnormal temperature changes based on the sensed data 501 and generate the cooling control information 511 accordingly; and make adjustments in real time through the cooling control information 511, thereby ensuring quick response under high load and preventing the system from overheating due to unexpected situations. The objective function of the cooling control model 311 is to minimize the maximum temperatures of the computing units or other components (e.g., the memory, a voltage regulator module (VRM), a network interface controller (NIC), a storage apparatus, a motherboard chip and motherboard components) while maintaining the energy efficiency, so as to ensure that the computing node 400 operates within a safe temperature range without generating excessive power consumption. The objective function f1 of the cooling control model 311 may be expressed as Formula 1, wherein max_temperature represents the maximum temperature of the computing units or other components, and energy_consumption represents the energy consumption.

f1=min(max_temperature, energy_consumption) Formula 1

In some embodiments, the sensed data 501 inputted into the cooling control model 311 includes temperature sensor data, workload data, environment conditions, power consumption data, historical thermal data, cooling system 700 status or/and safety thresholds. The temperature sensor data is real-time temperature sensor data of internal components (e.g., the computing unit) of the rack 440. The workload data is the current workload data of the computing units, including the task intensity and distribution that affect heat generation. The environment conditions include external factors such as ambient temperature, humidity and airflow pattern. The power consumption data includes the energy consumption status of the cooling system 700 and the computing units, and serves as a reference for balancing the cooling efficiency and the power consumption. The historical thermal data includes temperature trends recorded in the past and the response of the cooling system 700 to the workload and the environment conditions. The cooling system 700 status includes the current status such as the fan 722 speed, the coolant flow and the cooling capacity of the cooling system 700. The safety thresholds are predefined maximum temperature, fan 722 speed or/and coolant flow limit to prevent hardware from damage.

In some embodiments, the cooling control information 511 outputted by the cooling control model 311 includes predicted temperature changes, cooling adjustment suggestions, energy usage data, thermal stress indicators, cooling efficiency metrics, or/and cooling control constraints. The predicted temperature changes are predicted temperature fluctuations in future. The cooling adjustment suggestions are cooling mechanisms (e.g., fan 722 speed and coolant flow) that are recommended for execution or adjustment. The energy usage data is the current energy consumption and the estimated energy consumption of the cooling mechanisms in different cooling scenarios. The thermal stress indicators include potential overheating risks or hotspots between the internal components of the rack 440. The cooling efficiency metrics are efficacy data that shows the effectiveness of cooling control in cooling and energy consumption. The cooling control constraints are the limits or thresholds based on system parameters or safety limits (e.g., maximum fan 722 speed and minimum coolant flow).

In some embodiments, the load balancing model 312 is implemented based on decision trees or heuristic algorithms, so as to optimize resource distribution by analyzing the real-time workload and the cooling capacity of the cooling system 700 and ensure the uniform task distribution among the racks 440, thereby preventing overheating and efficacy bottlenecks. That is, the load balancing model 312 can generate the load balancing information 512 based on the real-time situations of the sensed data 501; and dynamically adjust the task priority through the load balancing information 512 so as to adapt to the workload changes. The objective function of the load balancing model 312 is to optimize resource distribution by minimizing the variance of the workload. This is helpful to preventing local overheating and maximizing the computing efficiency through uniform distribution of processing tasks. The objective function f2 of the load balancing model 312 may be expressed as Formula 2, wherein workload_variance represents the workload difference between the racks 440 or the computing units thereof.

f2=min(workload_variance) Formula 2

In some embodiments, the sensed data 501 inputted into the load balancing model 312 includes workload data, rack 440 load capacity, workload distribution metrics, temperature readings, resource availability, task priority data, network latency and bandwidth, and historical efficacy data. For the workload data, reference may be made to the foregoing description, and details will not be repeated here. The rack 440 load capacity is the available processing capacity and resources (e.g., the central processing unit, the graphics processing unit, the memory and other components) of the racks 440, which indicates how much additional load each component can process. The workload distribution metrics present the current distribution of tasks among the racks 440, which can highlight unbalanced or overused components. The temperature readings are the current temperatures of the racks 440 and the computing units to avoid overheating during task distribution. The resource availability includes information about idle or underutilized resources, for example, indicating the rack 440 or the specific computing unit therein that can undertake more tasks without affecting efficacy. The task priority data indicates the priorities of tasks, which may affect the way the workload is distributed. For example, high-priority tasks may require more direct or dedicated resources. The network latency and bandwidth are indicators of communication efficiency between the racks 440, which may affect task distribution decisions. The historical efficacy data is the workload distribution patterns and results in the past.

In some embodiments, the load balancing information 512 outputted by the load balancing model 312 includes current workload distribution, rack 440 load capacity, workload difference indicators, task redistribution suggestions, overheating risk indications and efficiency metrics. The current workload distribution is a snapshot of the distribution of tasks among the racks 440 or computing units thereof, which shows the current load of each resource. The rack 440 load capacity provides information about load capacity of each rack 440 or the computing units thereof, indicating which resources are underutilized or overloaded. The workload difference indicators provide data about workload distribution differences across resources, which highlights imbalances that may need to be adjusted. The task redistribution suggestions provide suggestions for adjusting task redistribution so as to ensure more uniform load distribution, improve computing efficiency and prevent efficacy bottlenecks. The overheating risk indications provide warnings about the racks 440 or the components thereof that are at risk of overheating due to high local workloads. The efficiency metrics show the efficacy indicators of resource utilization efficiency, including the impact of the current load balance on energy usage and computing efficiency.

In some embodiments, the predictive maintenance model 313 is implemented based on a statistical model, a support vector machine (SVM) or a neural network, and predicts potential hardware failures or performance degradation by analyzing historical data, sensor readings and computing efficiency metrics. That is, the predictive maintenance model 313 can analyze the historical data of the sensed data 501 to identify potential failure patterns and trends to generate the predictive maintenance information 513; and notify potential risks in advance and provide specific maintenance suggestions through the predictive maintenance information 513. The objective function of the predictive maintenance model 313 is to minimize the possibility of hardware failures by predicting and solving problems before they occur. In this way, maintenance can be arranged according to the predicted failure risk, thus ensuring system reliability and preventing unexpected downtime. The objective function f3 of the predictive maintenance model 313 may be expressed as Formula 3, wherein failure_risk represents the probability of hardware failures.

f3=min(failure_risk) Formula 3

In some embodiments, the sensed data 501 inputted into the predictive maintenance model 313 includes historical failure data, sensor readings, computing efficiency metrics, usage patterns, component life data, environment conditions, maintenance logs, diagnostic reports, or/and operational abnormalities. The historical failure data includes records of past hardware failures, efficacy problems and repair logs to help identify patterns that may indicate potential failures in future. The sensor readings include real-time data from temperature, vibration and other sensors that monitor the operation of hardware components (such as graphics processing units, central processing units and power supplies). The computing efficiency metrics are efficacy data of key computing components, including processing speed, power consumption and operation efficiency. The usage patterns are information about usage of computing components (such as the graphics processing units and the central processing units) over time, including workload intensity and running duration. The component life data is the expected life data of hardware components provided by manufacturers, which is used to predict when maintenance or replacement is needed. The environment conditions are data about external factors (such as ambient temperature, humidity and airflow), which may affect the life and health status of hardware components. The maintenance logs are records of previous maintenance actions, including which components to maintain and when to maintain them, for future reference in making maintenance plans. The diagnostic reports are automatic or manual diagnostic data, indicating the health status of each component. The operational abnormalities are abnormal behaviors of hardware efficacy detected, for example, a sudden increase in temperature or power consumption, which indicates that maintenance may be needed.

In some embodiments, the predictive maintenance information 513 outputted by the predictive maintenance model 313 includes predictive failure risks, component health status, maintenance plan suggestions, efficacy degradation indicators, system reliability metrics, or/and resource usage impact. The predictive failure risks provide warnings and risk scores of the possibility of failures or efficacy degradation of hardware components (such as the graphics processing units and the central processing units). The component health status provides current diagnosis of the health status of key computing components according to the sensor data and historical efficacy. The maintenance plan suggestions include suggested schedules for pre-maintenance or replacement of components at risk of failure. The efficacy degradation indicators are data on the ongoing or expected degradation of computing performance due to component loss or efficiency degradation. The system reliability metrics are expected system reliability information under the assumption that maintenance is not performed, which is helpful to evaluating the urgency of maintenance tasks. The resource usage impact includes data on how predictive maintenance operations (such as component replacement and cooling adjustment) affect resource availability and workload distribution.

After obtaining the information outputted by the aforementioned artificial intelligence model 310, the meta-controller 330 makes a coordinated decision (step 502) to generate the thermal management decision 800. Specifically, the meta-controller coordinates cooling adjustment 521, workload redistribution 522 and maintenance plan making 523 respectively with tasks corresponding to the three models in the artificial intelligence model 310 to make a high-level decision, so as to enhance the collaborative optimization among the artificial intelligence models 310. In some embodiments, the meta-controller 330 has the ability of decision interpretation, and can provide the reasons and basis behind the decision. In some embodiments, the thermal management decision 800 includes cooling adjustment instructions, workload redistribution instructions, maintenance plan indications and risk warning suggestions. The cooling adjustment instructions indicate the cooling mechanisms to execute the adjustment contents (such as the fan 722 speed and the coolant flow). The workload redistribution instructions indicate how the tasks are redistributed among the racks 440 or the computing units thereof. The maintenance plan indications include preventive maintenance plans to ensure that components are repaired or replaced before they cause heat dissipation problems. The risk warning suggestions include notices about potential overheating risks or hardware failures and specific suggestions for thermal management adjustments to reduce risks. The meta-controller 330 provides data-driven insights and feedback loops, constantly refines decisions on cooling control and workload distribution, optimizes energy usage and system reliability, and ensures that computing node 400 operates within the target ranges of efficacy and energy efficiency.

The output objectives of the meta-controller 330 involve minimizing decision errors, improving the accuracy of interpretation and enhancing the relevance of suggestions. In some embodiments, the meta-controller 330 is a large language model. Through the reasoning ability of the large language model, the meta-controller 330 can ensure that the decisions are consistent with the global objective of the system, such as optimizing efficiency, maintaining thermal stability and preventing hardware failures. The objective function of the large language model determines how it interprets, reasons about and coordinates the output of the artificial intelligence model 310. The objective function f4 of the meta-controller 330 may be expressed as Formula 4, which minimizes the indicators in the function, wherein decision_errors represents decision errors, conflict_resolution represents an effective resolution of the target conflict among the models in the artificial intelligence model 310, system_coordination represents a smooth and integrated operation among the models in the artificial intelligence model 310, coordinated_management represents coordination of the operations among the models in the artificial intelligence model 310, trade_off_management represents trade-off management balancing the competition between the objectives (such as the trade-off between cooling efficiency and hardware life), and scalable_decision_making represents scalability, which means adjusting the decision-making process to adapt to the growth and increasing complexity of the system.

f4=min(decision_errors, conflict_resolution, system_coordination, coordinated_management, trade_off_management, scalable_decision_making) Formula 4

In an embodiment, the system-level objective function of the cognitive computing system 300 is a composite function, which combines the component-level objective functions (f1-f4) to achieve the global system objective. The system-level objective function is expressed as Formula 5. The meta-controller 330 distributes a weight w1-w4 respectively to the objective functions f1-f4 corresponding to the models in the artificial intelligence model 310 and the large language model to obtain the system-level objective function F. Thereby, the meta-controller 330 makes the decision based on the system-level objective function F. The weights w1-w4 distributed to the objective functions f1-f4 reflect the importance of the corresponding model. Therefore, the meta-controller 330 determines a priority order of the models in the corresponding artificial intelligence model 310 and the large language model according to the weights w1-w4 to make the decision. The meta-controller 330 may dynamically adjust the weights according to the current system conditions and priorities, so that the meta-controller 330 can intelligently balance the trade-offs between different objectives and ensure that the outputs of all the models (including its own outputs) are effectively coordinated.

=F(w1*f1+w2*f2+w3*f3+w4*f4) Formula 5

For example, when the computing node 400 is running at high efficacy, a sudden increase in workload will generate excessive heat. The cooling system 700 has been running at the maximum cooling capacity, but the temperature is still increasing. The meta-controller 330 detects that the impact of cooling control (objective function f1) has reached its limit, while the predictive maintenance (objective function f3) shows that the hardware has potential signs of degradation due to overheating. In order to prevent system failures, the meta-controller 330 dynamically increases the weight w3 of the predictive maintenance so as to give priority to hardware inspection in advance and reduce the risk of component failures. Moreover, the weight w1 of the cooling control is reduced, because the cooling adjustment is not enough to solve the problem of reducing the excessive heat at this time. The meta-controller 330 further adds the weight w2 of load balancing to redistribute the workload to the computing unit with low utilization rate, so as to reduce the generation of local heat. The meta-controller 330 performs reasoning based on the input information from the models in the artificial intelligence model 310, so as to adjust the corresponding weights w1-w4 and ensure that the computing node 400 remains stable, efficient and reliable under dynamic conditions.

As shown in FIG. 5, after the meta-controller 330 makes the thermal management decision 800 (step 502), the meta-controller 330 notifies the thermal management system 410 to execute the thermal management decision 800 (step 503). The meta-controller 330 continuously monitors the actions of the thermal management system 410 and the results of executing the thermal management decision 800 through the monitoring system (step 504), for example, whether cooling adjustment reduces the temperature, or whether task redistribution improves the workload balance. These results of executing the thermal management decision 800 will be retained as historical data as a reference for subsequent improvements.

In step 505, the meta-controller 330 analyzes the differences between the results of executing the thermal management decision 800 and the result previously predicted by the artificial intelligence model 310. These errors or deviations (such as insufficient cooling or unsatisfactory task distribution) will be retained as historical data as a reference for subsequent improvements.

In step 506, the meta-controller 330 dynamically adjusts the weights w1-w4 of the models according to the real-time efficacy. For example, if the temperature increase makes cooling control important, the weight w1 of the cooling control model 311 will be increased, and thus will have a higher priority than other models. Through the dynamic weight adjustment, the resources of the computing node 400 can be effectively distributed, so as to effectively respond to key conditions.

In step 507, the meta-controller 330 further selectively updates the artificial intelligence model 310 incrementally. Specifically, the meta-controller 330 takes the differences analyzed in step 505 as feedback to evaluate which model or models in the artificial intelligence model 310 need to be updated. The meta-controller 330 then updates the corresponding model(s) incrementally to fine-tune the model(s) according to the real-time feedback. For example, if the cooling adjustment does not achieve the expected effect, the cooling control model 311 is updated. The meta-controller 330 is responsible for coordinating the updating of models in the artificial intelligence model 310, so as to avoid conflicts in adjustment among models of the artificial intelligence model 310. In this way, each model in the artificial intelligence model 310 can learn from the environment over time to fine-tune its decision-making capacity, thereby ensuring that the artificial intelligence model 310 can adapt to changes quickly. Through incremental learning, the efficacy of the artificial intelligence model 310 can be improved without interrupting the real-time operation, so there is no need to retrain the artificial intelligence model 310.

Still referring to FIG. 1, in an embodiment, the thermal management optimization apparatus 100 further includes a meta-optimizer 200. The meta-optimizer 200 is coupled to the cognitive computing system 300 and configured to continuously optimize the cognitive computing system 300. Specifically, the meta-optimizer 200 generates a new cognitive computing system 300 according to the past cognitive computing system 300 so as to adapt to the dynamic environment with frequent thermal changes. That is, the meta-optimizer 200 provides a real-time learning function, and can generate the new cognitive computing system 300 according to the historical data (including the latest data) so as to dynamically adjust the policy and give consideration to the trade-offs between different objectives (multi-objective optimization). In some embodiments, the meta-optimizer 200 is implemented based on a proximal policy optimization (PPO) algorithm. PPO is often considered a subclass of actor-critic methods, which update the policy gradients based on the value function. PPO uses the advantage function. The advantage function measures the amount by which the cumulative reward (based on the policy implemented by the actor) exceeds the expected baseline reward (as predicted by the critic). The goal of PPO is to increase the likelihood of choosing actions with a high advantage. The optimization objective of PPO uses loss functions based on the advantage function. The meta-optimizer 200, implemented using PPO, configured to generate a new Cognitive AI System by optimizing component weights based on historical thermal and performance data.

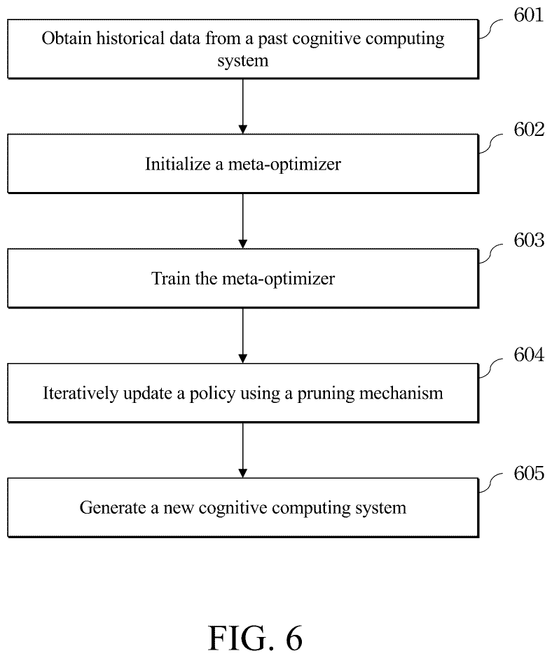

FIG. 6 is a schematic diagram showing an operation process of a meta-optimizer 200 according to an embodiment of the present disclosure.

In step 601, historical data is collected from the past cognitive computing system 300. The historical data includes decision data, efficacy indicators and situation data. The decision data includes cooling control patterns, load balancing decisions, predictive maintenance activities and impact thereof on the efficacy of the computing node 400. The efficacy indicators include key efficacy indicators such as thermal profile, energy efficiency, hardware life and failure rate. The situation data includes environmental factors such as ambient temperature, airflow conditions and system workload. Through the historical data, the meta-optimizer 200 can fully understand the efficacy, decision and activity results of the system under various conditions.

In step 602, the meta-optimizer 200 is initialized, including framework setting, policy representation and reward function definition. The framework setting is to design the policy model to determine how to generate the new cognitive computing system 300 by adjusting its components according to the historical data. The policy representation is to define a policy, and output an optimized policy for the new cognitive computing system 300 by using the historical data as the input. The reward function is defined based on the objectives of maintaining the optimal temperature, minimizing the energy consumption and preventing the hardware failures, and can balance different objectives (such as temperature control, energy efficiency, etc.).

In step 603, the meta-optimizer 200 performs training, including environment setting, exploration and utilization, and policy updating. The environment setting is to set the training environment of the meta-optimizer 200, so as to simulate the real-time workload, cooling control behaviors, thermal profile and other conditions of the computing node 400 according to the historical data. The exploration and utilization is to explore different configurations by adjusting the weights w1-w3 and policies of the models in the artificial intelligence model 310. In the training process, the meta-optimizer learns the best action by interacting with the simulated environment, exploring new policies and utilizing the balance between known effective policies.

In step 604, a pruning mechanism is used to iteratively update the policy incrementally to ensure a stable update of the policy, so that the cognitive computing system 300 can be continuously optimized. In detail, the meta-optimizer 200 constantly adjusts the policy according to the environment, and it learns from the past decisions and adjusts the weights w1-w3 of the models in the artificial intelligence model 310 to optimize the system-level performance. The adjusted policy can maximize the reward, which ensures that the new cognitive computing system 300 meets the constantly changing needs. For example, when signs of hardware degradation are detected, priority will be given to cooling efficiency or predictive maintenance in the high-temperature environment. The meta-optimizer 200 utilizes the empirical insights of the past cognitive computing system 300, to ensure that the learned policy can adapt to the new thermal profile and workload and adapt to the new conditions without complete retraining.

In step 605, after the meta-optimizer 200 extracts the effective policy by analyzing the past cognitive computing system 300, it can generate the new cognitive computing system 300 by adjusting the role and coordination of the artificial intelligence model 310. The meta-optimizer 200 can dynamically adjust the weights w1-w3 of the models in artificial intelligence model 310 to form the new cognitive computing system 300. For example, under the high-temperature conditions, the weight w1 of the cooling control is increased; or, when there is a high failure risk, the weight w3 of the predictive maintenance is increased. Through steps 601 to step 605 above, the meta-optimizer 200 can continuously optimize and generate the new cognitive computing system 300 according to the real-time situation, so as to dynamically adapt to the change in thermal profile. Moreover, since the meta-optimizer 200 can scale new policies that meet new conditions from the historical data of the past cognitive computing system 300, the new cognitive computing system 300 has scalability.

According to the thermal management optimization apparatus 100 and the thermal management optimization method executed thereby in some embodiments of the present disclosure, a three-tier architecture is provided. The first tier is models with independent objectives (including the artificial intelligence model 310 and the large language model). The second tier is the cognitive computing system 300 that integrates these models, which coordinates the outputs of the models to achieve the global objective and can adapt to specific thermal profile. The third tier is the meta-optimizer 200, which can customize and generate the new cognitive computing system 300 according to the change in the thermal profile environment. By improving the adaptability and intelligence level tier by tier, the static artificial intelligence capacity is transformed into a comprehensive solution that adapts to the dynamic environment. Thereby, the thermal management of the computing node 400 can stay stable and efficient, and has adaptability and scalability, and does not need frequent manual intervention.

In order to illustrate the effect of the provided three-tier architecture, the following tests are respectively conducted on two aspects, namely, “completely customized to process the new thermal profile” and “dynamically adapting to constantly changing demands”. First, the aspect of “completely customized to process the new thermal profile” will be explained in terms of temperature stability, energy consumption efficiency, hardware life extension and performance optimization.

In terms of the temperature stability, temperature data of the graphics processing unit at high and low loads is collected, and the stability and fluctuation range are observed and recorded. The temperature fluctuation range of the three-tier architecture is within ±2 °C. In contrast, the fluctuation of the traditional artificial intelligence model reaches ±5 °C-10 °C.

In terms of the energy consumption efficiency, the cooling energy consumptions in different load situations are measured. The cooling energy consumption of the three-tier architecture is reduced by 5%-10% at high low load, and can be reduced by 10%-15% at low load.

In terms of the hardware life extension, by long-term running of test data, whether high-temperature running time is successfully reduced is observed. The running time of the graphics processing unit of the three-tier architecture above 90 °C is reduced by 20%, so it can be estimated that the service life of hardware is extended by about 20%-30%.

In terms of the performance optimization, the performance support capacity is tested at different loads. In particular, the three-tier architecture avoids thermal throttling in the temperature management policy, so that the overall performance is improved by 5%-10%. The task completion time can be shortened by 10%-15% at high load.

In another aspect, the effect of “dynamically adapting to constantly changing demands” of the three-tier architecture will be explained in terms of load change coping capacity, cooling efficiency and power consumption management, continuous stability in a changing environment, and multi-objective adjustment capacity.

In terms of the load change coping capacity, the tests are conducted in multiple load situations (including situation changes among continuous high load, sudden load increase and low load). The three-tier architecture can shorten the temperature control delay to less than 10 seconds in the case of the load increase. In contrast, the delay of the traditional artificial intelligence model may reach 30 seconds.

In terms of the cooling efficiency and power consumption management, power consumption and cooling efficiency are measured in different temperature change situations. When the load is reduced from high to low, the three-tier architecture reduces the cooling power consumption by 10%-15% within 30 seconds. In contrast, the traditional artificial intelligence model takes several minutes to adjust to a stable state.

In terms of the continuous stability in a changing environment, the cooling response and temperature control effect are tested at different ambient temperatures (for example, the ambient temperature is changed from 20 °C to 30 °C). The three-tier architecture can automatically adjust the cooling strength in different environments, so that the internal temperature fluctuation can be kept within the range of ±2 °C. In contrast, the temperature fluctuation of the traditional artificial intelligence model reaches ±5 °C.

In terms of the multi-objective adjustment capacity, different objective demands (e.g., cooling first, energy-saving first, etc.) are introduced in the test, and the real-time adjustment capacity is measured. When the demand becomes energy-saving first, the three-tier architecture can reduce the cooling power consumption by 20%. When the demand is performance first, the cooling strength is increased to maintain the optimal efficacy, showing its flexible adjustment capacity.

What is claimed is:

1. A thermal management optimization method, comprising:
generating, using an artificial intelligence model, predictive information based on sensed data;
generating, by a meta-controller, a thermal management decision based on the predictive information;
providing the thermal management decision to a thermal management system of a computing node for execution; and
executing the thermal management decision by at least one of: adjust an operation of a cooling system of the thermal management system, and adjust a workload distribution of the computing node.

2. The thermal management optimization method according to claim 1, wherein a cognitive computing system is formed by the artificial intelligence model and the meta-controller, and the meta-controller is a large language model.

3. The thermal management optimization method according to claim 2, further comprising:
optimizing, by a meta-optimizer, the cognitive computing system.

4. The thermal management optimization method according to claim 3, wherein optimizing the cognitive computing system is generating a new cognitive computing system according to a past cognitive computing system.

5. The thermal management optimization method according to claim 4, wherein generating the new cognitive computing system according to the past cognitive computing system comprises:
collecting historical data of the past cognitive computing system; and
analyzing the past cognitive computing system to extract effective policies to generate the new cognitive computing system.

6. The thermal management optimization method according to claim 5, wherein the artificial intelligence model comprises a cooling control model, a load balancing model and a predictive maintenance model, and the meta-optimizer further dynamically adjusts a weight corresponding to the cooling control model, the load balancing model and the predictive maintenance model.

7. The thermal management optimization method according to claim 6, further comprising:
selectively updating the artificial intelligence model incrementally.

8. The thermal management optimization method according to claim 3, wherein the meta-optimizer is implemented based on a proximal policy optimization algorithm.

9. The thermal management optimization method according to claim 2, further comprising:
distributing, by the meta-controller, a weight to an objective function corresponding to the artificial intelligence model and the large language model respectively to obtain a system-level objective function; and
making, by the meta-controller, the decision based on the system-level objective function.

10. The thermal management optimization method according to claim 9, wherein the making, by the meta-controller, the decision based on the system-level objective function is determining a priority order of the artificial intelligence model corresponding to and the large language model according to a plurality of weights to make the decision.

11. The thermal management optimization method according to claim 9, further comprising:
dynamically adjusting each of the plurality of weights.

12. The thermal management optimization method according to claim 1, further comprising:
monitoring, by the meta-controller, a result of executing the thermal management decision by the thermal management system.

13. The thermal management optimization method according to claim 1, wherein the artificial intelligence model comprises a cooling control model, and the predictive information comprising cooling control information is generated based on the sensed data.

14. The thermal management optimization method according to claim 1, wherein the artificial intelligence model comprises a load balancing model, and the predictive information comprising load balancing information is generated based on the sensed data.

15. The thermal management optimization method according to claim 1, wherein the artificial intelligence model comprises a predictive maintenance model, the predictive information comprising predictive maintenance information is generated based on the sensed data.

16. A non-transitory computer-readable storage medium, storing a plurality of instructions loaded to execute the thermal management optimization method according to claim 1.

17. A thermal management optimization apparatus, comprising:
one or more processors configured to, using an artificial intelligence model, generate predictive information based on sensed data;
a meta-controller, coupled to the artificial intelligence model, configured to generate a thermal management decision based on the predictive information and provide the thermal management decision to a thermal management system of a computing node for execution; and
a cooling system configured to execute the thermal management decision by adjusting at least one of: a liquid cooling device, and an air cooling device.

18. The thermal management optimization apparatus according to claim 17, further comprising: a meta-optimizer configured to optimize a cognitive computing system formed by the artificial intelligence model and the meta-controller.

19. The thermal management optimization apparatus according to claim 18, wherein the meta-controller is further configured to distribute a weight to an objective function corresponding to the artificial intelligence model and a large language model respectively to obtain a system-level objective function and make the decision based on the system-level objective function.

20. The thermal management optimization apparatus according to claim 19, wherein a plurality of weights are dynamically adjusted by the meta-controller or the meta-optimizer.
